(19) United States
(12) Patent Application Publication
(10) Pub. No.: US 2008/0312900 A1
(43) Pub. Date: Dec. 18, 2008

(54) SIMULATION APPARATUS AND SIMULATION METHOD

(75) Inventors: Takashi AKIBA, Kawasaki-Shi (JP); Takashi Miura, Yokohama-Shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/133,061

(22) Filed: Jun. 4, 2008

(30) Foreign Application Priority Data
Jun. 18, 2007 (JP) 2007-159951

(51) Int. Cl. G06F 9/455

(52) U.S. Cl. 703/23

(57) ABSTRACT

According to the present invention, there is provided a simulation apparatus having, a hardware emulator which includes a first CPU core as a simulation target, and a debug control unit; a software simulator which includes a second CPU core as a simulation target, and a clock generation unit which generates a clock and supplies the clock to the first CPU core and the second CPU core; and a debugger which debugs the first CPU core and the second CPU core and in which a clock disable condition is set, wherein upon determining that the clock disable condition set in the debugger is satisfied, the debug control unit outputs a clock disable signal, and upon receiving the clock disable signal, the clock generation unit stops generating the clock.

### CROSS REFERENCE TO RELATED APPLICATION

This application is based upon and claims benefit of priority under 35 USC §119 from the Japanese Patent Application No. 2007-159951, filed on Jun. 18, 2007, the entire contents of which are incorporated herein by reference.

### BACKGROUND OF THE INVENTION

The present invention relates to a simulation apparatus and method and, more particularly, to a simulation apparatus and method which execute cooperative simulation between a hardware emulator and a software simulator.

In a recent system LSI with a large scale, if a defect of architecture level is found after formation on a chip, much time and cost are necessary for correcting it. To prevent this, in developing a system LSI, the design quality and development efficiency are improved by reusing a block or module of a verified existing design or conducting stepwise verification based on a top-down design methodology. Such verification of system level requires a verification technology applicable to an overall system. A high accuracy is necessary for verification using simulation.

In the simulation, software simulation and a hardware emulator that executes simulation using a programmable device (e.g., FPGA (Field Programmable Gate Array)) are used.

A hardware emulator can operate faster than a software simulator by several orders of magnitude. However, the emulatable circuit scale is limited from the viewpoint of the scale and cost of the elements of a programmable device. To solve this problem, a method of performing simulation by making a hardware emulator and a software simulator cooperate has been proposed.

In such cooperative simulation, a debugger debugs a CPU core serving as a DUT (Design Under Test) in the hardware emulator and a CPU core in the software simulator.

A multi CPU core can be debugged using, e.g., JTAG-ICE (Joint Test Action Group). In this method, however, when, e.g., a CPU core has reached a breakpoint, and simulation has stopped, another CPU core stops with a delay of about 1 msec (the Jan. 2, 2006, issue of Nikkei Electronics, p. 122).

This is because one cycle is necessary for notifying the JTAG-ICE of the stop of the CPU core, and one more cycle is necessary for causing the JTAG-ICE to stop the other CPU core.

This changes the number of execution cycles between the CPU cores each time they stop at a breakpoint or the like, resulting in poor simulation accuracy.

A reference that discloses a conventional simulation method based on cooperation of a hardware emulator and a software simulator will be described below.

US2006/0036427

### SUMMARY OF THE INVENTION

According to one aspect of the present invention, there is provided a simulation apparatus, comprising: a hardware emulator which includes a first CPU core as a simulation target, and a debug control unit; a software simulator which includes a second CPU core as a simulation target, and a clock generation unit which generates a clock and supplies the clock to the first CPU core and the second CPU core; and a debugger which debugs the first CPU core and the second CPU core and in which a clock disable condition is set, wherein upon determining that the clock disable condition set in said debugger is satisfied, said debug control unit outputs a clock disable signal, and upon receiving the clock disable signal, said clock generation unit stops generating the clock.

According to one aspect of the present invention, there is provided a simulation apparatus, comprising: a hardware emulator which includes a first CPU core as a simulation target, an emulator operation control unit which generates a clock and supplies the clock to the first CPU core, and a debug control unit; a software simulator which includes a second CPU core as a simulation target, a simulator operation control unit which generates a clock and supplies the clock to the second CPU core, and a cooperative operation control unit which cooperates an operation of said emulator operation control unit and that of said simulator operation control unit; and a debugger which debugs the first CPU core and the second CPU core and in which a clock disable condition is set, wherein upon determining that the clock disable condition set in said debugger is satisfied, said debug control unit outputs a clock disable signal, upon receiving the clock disable signal, said emulator operation control unit outputs an operation stop interrupt signal, and upon receiving the operation stop interrupt signal, said cooperative operation control unit outputs synchronization/control information to said emulator operation control unit and said simulator operation control unit so that said emulator operation control unit and said simulator operation control unit stop generating the clock.

According to one aspect of the present invention, there is provided a simulation method of executing simulation for debugging a first CPU core and a second CPU core by using a simulation apparatus including a hardware emulator which includes the first CPU core as a simulation target, and a debug control unit, a software simulator which includes the second CPU core as a simulation target, and a clock generation unit which generates a clock and supplies the clock to the first CPU core and the second CPU core, and a debugger which debugs the first CPU core and the second CPU core and in which a clock disable condition is set, comprising: causing the debug control unit to determine whether the clock disable condition set in the debugger is satisfied; and causing the clock generation unit to stop generating the clock when the debug control unit determines that the clock disable condition is satisfied.

### BRIEF DESCRIPTION OF THE DRAWINGS

FIG. 1 is a block diagram showing the arrangement of a simulation apparatus according to the first embodiment of the present invention;

FIG. 2 is an explanatory view showing the operation contents of a hardware emulator and a software simulator in the simulation apparatus;

FIG. 3 is an explanatory view showing the operation contents of the hardware emulator and a debugger in the simulation apparatus;

FIG. 4 is a timing chart showing the timing of causing a debug control unit in the hardware emulator of the simulation apparatus to control the clock generation operation of a clock generation unit in the software simulator; and

FIG. 5 is a block diagram showing the arrangement of a simulation apparatus according to the second embodiment of the present invention.

### DETAILED DESCRIPTION OF THE INVENTION

The embodiments of the present invention will now be described with reference to the accompanying drawings.

### (1) First Embodiment

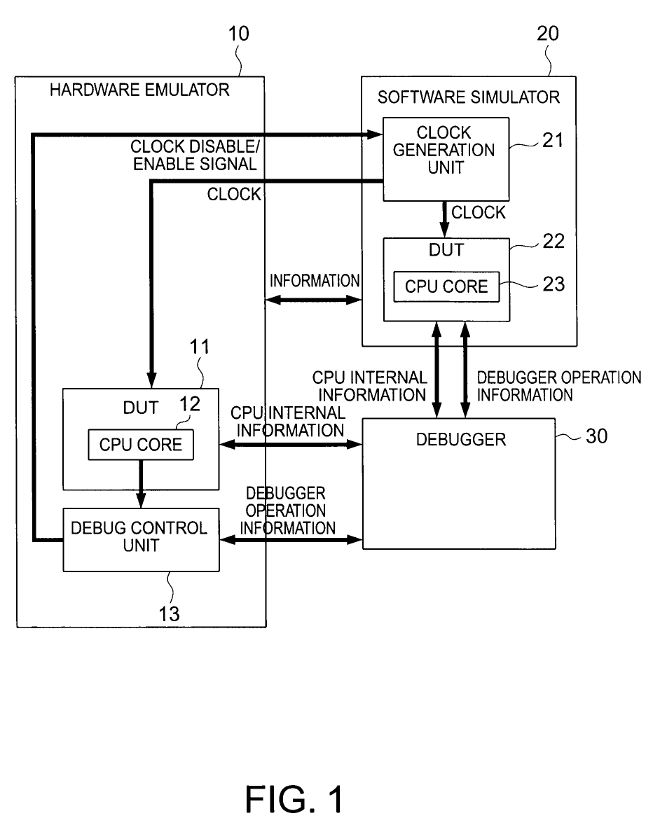

FIG. 1 shows the arrangement of a simulation apparatus according to the first embodiment of the present invention.

This simulation apparatus includes a hardware emulator 10, software simulator 20, and debugger 30.

The hardware emulator 10 has a CPU core 12 serving as a DUT 11, and a debug control unit 13 which receives debugger operation information and transmits a clock disable/enable signal for disabling or enabling a clock to the software simulator 20. The software simulator 20 has a clock generation unit 21 which generates a clock, and a CPU core 23 serving as a DUT 22. The debugger 30 exchanges CPU internal information between the CPU cores 12 and 23 and also exchanges debugger operation information between the debug control unit 13 and the CPU core 23, thereby debugging the CPU cores 12 and 23.

The simulation apparatus performs cooperative simulation by operating the CPU core 12 in the hardware emulator 10 and the CPU core 23 in the software simulator 20 in synchronism with the clock generated by the clock generation unit 21 in the software simulator 20.

The debugger 30 executes the debug operation while receiving CPU internal information about the states of a program counter and register in each of the CPU cores 12 and 23 and outputting debugger operation information about the debug operation to the debug control unit 13 and CPU core 23.

When the CPU core 12 in the hardware emulator 10 reaches a breakpoint, the debugger 30 outputs debugger operation information to the debug control unit 13 to disable the clock. Upon receiving the debugger operation information, the debug control unit 13 supplies a clock disable/enable signal for notifying to disable the clock to the clock generation unit 21 in the software simulator 20 so that clock generation stops. Since clock supply from the clock generation unit 21 to the CPU cores 12 and 23 stops, the debug operation stops.

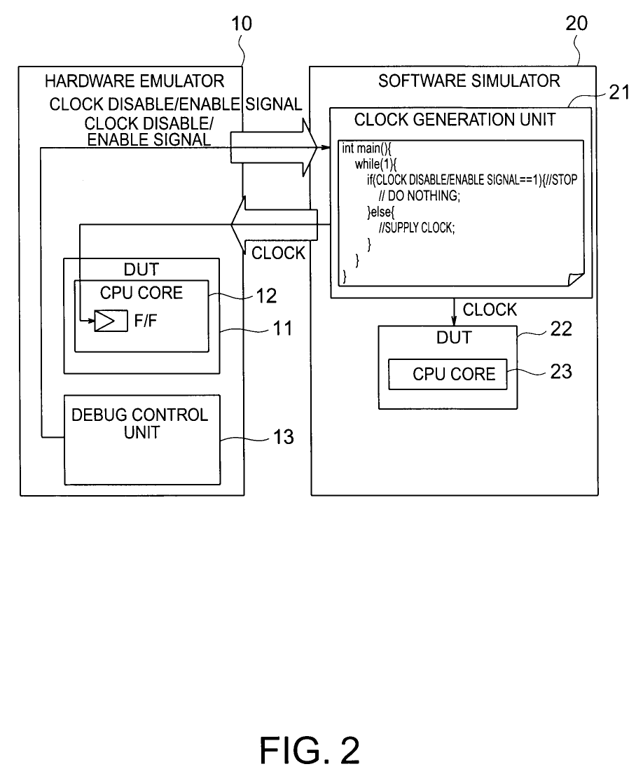

FIG. 2 shows the signal transmission/reception and operation procedure between the debug control unit 13 and the clock generation unit 21.

The debug control unit 13 receives debugger operation information from the debugger 30 (not shown) and supplies the clock disable/enable signal to the clock generation unit 21. The clock generation unit 21 has a clock generation function as shown in FIG. 2. When the clock disable/enable signal has logic “1”, the clock generation unit 21 disables the clock. When the clock disable/enable signal has logic “0”, the clock generation unit 21 enables the clock. When the clock is disabled, clock supply from the clock generation unit 21 to the CPU cores 12 and 23 stops.

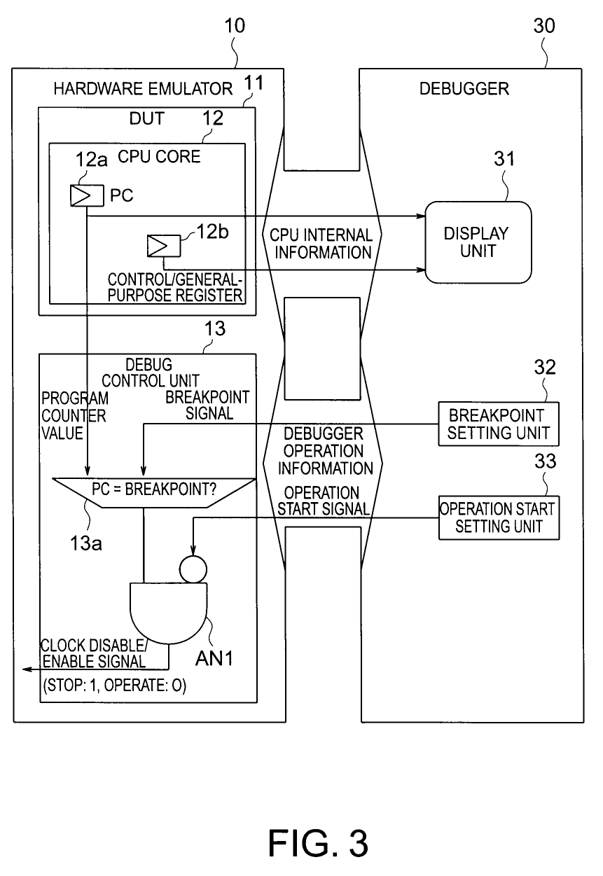

FIG. 3 shows the signal transmission/reception and operation procedure between the hardware emulator 10 and the debugger 30.

The CPU core 12 of the hardware emulator 10 includes a program counter 12a that stores an address of a program running in the CPU core 12, and a control/general-purpose register 12b.

A display unit 31 of the debugger 30 displays, e.g., data held by the register or a source code to be debugged as the internal information held by the program counter 12a and control/general-purpose register 12b of the CPU core 12.

A breakpoint is set in a breakpoint setting unit 32 of the debugger 30. The set data is held until a change. The breakpoint setting unit 32 outputs a breakpoint signal to a breakpoint determination unit 13a.

Setting is done in an operation start setting unit 33 to stop an operation at the breakpoint or resume an operation that has temporarily stopped at, e.g., the breakpoint. The operation start setting unit 33 outputs an operation start signal to an AND circuit AN1. When the operation start signal has logic “0”, the operation can stop at the breakpoint. When the operation start signal has logic “1”, the operation starts.

The breakpoint determination unit 13a of the debug control unit 13 receives a program counter value from the program counter 12a and a breakpoint signal from the breakpoint setting unit 32 and determines whether the values match. While the values do not match, the breakpoint determination unit 13a outputs a mismatch signal of logic “0” to the AND circuit AN1. When the values match, the breakpoint determination unit 13a outputs a match signal of logic “1” to the AND circuit AN1.

Upon receiving the match signal of logic “1” and a signal of logic “1” which is obtained by inverting a disable/enable signal of logic “0” from the operation start setting unit 33, the AND circuit AN1 outputs a clock disable/enable signal of logic “1”. Otherwise, the AND circuit AN1 outputs a clock disable/enable signal of logic “0”.

When the clock disable/enable signal of logic “1” is supplied to the clock generation unit 21, the clock generation operation stops. Accordingly, the CPU core 12 in the hardware emulator 10 and the CPU core 23 in the software simulator 20 simultaneously stop the operation without any time lag.

When the operation temporarily stops at the breakpoint, the value in the program counter 12a stops at the breakpoint. In this state, the user sets an operation start in the operation start setting unit 33 of the debugger 30. Then, the operation start setting unit 33 outputs an operation start signal of logic “1”. This signal is inverted so that a signal of logic “0” is input to the AND circuit AN1. The AND circuit AN1 outputs a clock disable/enable signal of logic “0”. The clock generation unit 21 resumes the operation of supplying the clock to the CPU cores 12 and 23. The CPU cores 12 and 23 simultaneously start the operation.

When the settings associated with the breakpoint and operation start are done and held in the debugger 30, clock synchronization between the hardware emulator 10 and the debugger 30 becomes unnecessary up to the breakpoint.

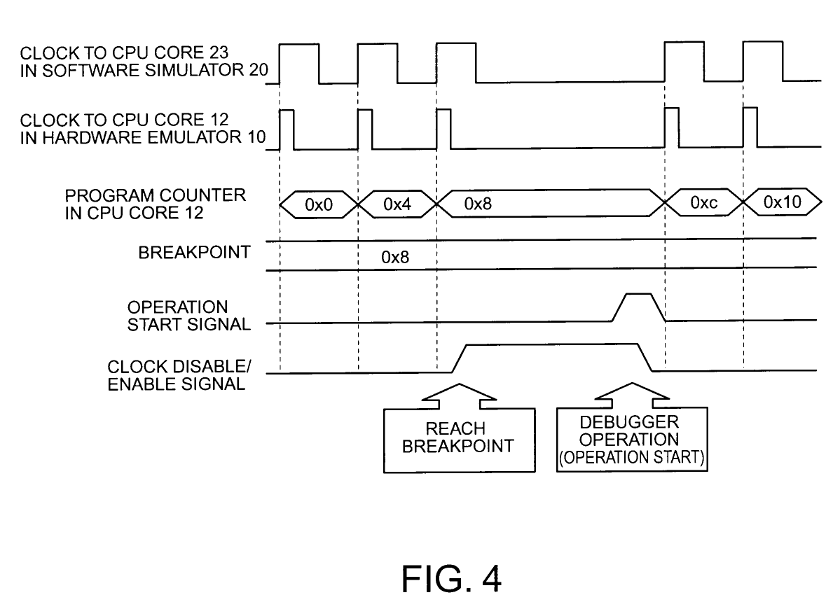

FIG. 4 shows the waveforms of various signals until the clock supply and the operation of the CPU cores 12 and 23 stop at a breakpoint. The operation procedures will be described as follows:

1) A breakpoint (“0×8” in FIG. 4) for the CPU core 12 in the hardware emulator 10 is set in the breakpoint setting unit 32 of the debugger 30.

2) An operation start (logic “1”) for operating the CPU core 12 in the hardware emulator 10 is set in the operation start setting unit 33 of the debugger 30.

3) In the debug control unit 13, the AND circuit AN1 outputs a clock disable/enable signal of logic “0” to cause the clock generation unit 21 to generate the clock.

4) The clock generation unit 21 generates the clock and supplies it to the CPU core 12 in the hardware emulator 10 and the CPU core 23 in the software simulator 20, as shown in FIG. 4.

5) The clock generation unit 21 generates the clock until the breakpoint (“0×8”) set in the breakpoint setting unit 32 of the debugger 30 matches the value of the program counter 12a of the hardware emulator 10, and the operation start setting unit 33 of the debugger 30 outputs an operation start signal of logic “0”.

6) The value of the program counter 12a reaches the breakpoint, and the operation start setting unit 33 outputs the operation start signal of logic “0”. Then,

(A) The debug control unit 13 outputs a clock disable/enable signal (logic “1”) for disabling the clock to the clock generation unit 21.

(B) Clock supply from the clock generation unit 21 to the CPU cores 12 and 23 stops.

(C) The control/general-purpose register 12b in the hardware emulator 10 sends the internal information of the CPU core 12, including, e.g., the values of the control register and general-purpose register, to the debugger 30, and the display unit 31 displays the information.

7) An operation start is set in the operation start setting unit 33 of the debugger 30, and the operation start setting unit 33 outputs an operation start signal of logic “1”. A clock disable/enable signal of logic “0” is output so that the clock generation unit 21 resumes clock generation.

In a simulation apparatus according to a comparative example, when a breakpoint existed in a program that was being executed by a CPU core in a hardware emulator, a debugger outputs an instruction to the CPU cores in the hardware emulator and software simulator to stop their operation. Hence, the CPU cores stopped the operation with a time lag.

However, according to the first embodiment, when a program that is being executed by the CPU core in the hardware emulator reaches a breakpoint, the debug control unit 13 in the hardware emulator 10 notifies to disable the clock to the clock generation unit 21 in the software simulator 20. This allows to simultaneously stop the CPU cores 12 and 23 without any delay.

Even when the operation stopped at the breakpoint is resumed, the number of execution cycles does not change between the plurality of CPU cores. It is therefore possible to increase the simulation accuracy.

### (2) Second Embodiment

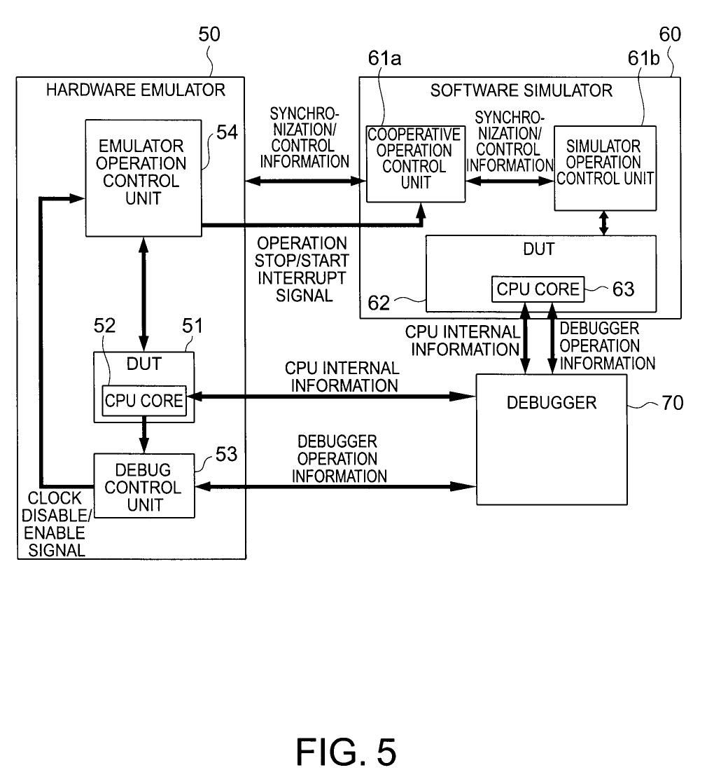

A simulation apparatus according to the second embodiment of the present invention will be described with reference to FIG. 5 that shows the arrangement.

In the first embodiment, only the clock generation unit 21 provided in the software simulator 20 generates the clock and supplies it to the CPU core 23 in the software simulator 20 and the CPU core 12 in the hardware emulator 10.

In the second embodiment, an emulator operation control unit 54 in a hardware emulator 50 generates a clock and supplies it to a CPU core 52 in the hardware emulator 50.

Additionally, a software simulator 60 incorporates a simulator operation control unit 61b which generates a clock to be supplied to a CPU core 63 in the software simulator 60. The software simulator 60 also incorporates a cooperative operation control unit 61a which synchronizes/cooperates the clock generation operation between the emulator operation control unit 54 and the simulator operation control unit 61b.

The arrangements of the CPU core 52, debug control unit 53, and debugger 70 are the same as those of the CPU core 12, debug control unit 13, and debugger 30 according to the first embodiment shown in FIGS. 2 and 3. Additionally, the operation until the value of the program counter of the CPU core 52 in the hardware emulator 50 reaches a breakpoint preset in the debugger 70, and the debug control unit 53 outputs a clock disable signal for disabling the clock is the same as in the first embodiment, and a description thereof will not be repeated.

The clock disable signal is temporarily input to the emulator operation control unit 54 in the hardware emulator 50, and the emulator operation control unit 54 inputs an operation stop interrupt signal to the cooperative operation control unit 61a in the software simulator 60. After that, the cooperative operation control unit 61a outputs synchronization/control information simultaneously to the emulator operation control unit 54 and the simulator operation control unit 61b to disable the clock. The emulator operation control unit 54 stops clock supply to the CPU core 52, and the simulator operation control unit 61b stops clock supply to the CPU core 63. That is, they stop the operation simultaneously.

When the user sets an operation start in the operation start setting unit of the debugger 70 upon disabling the clock, the debug control unit 53 outputs a clock enable signal, as in the first embodiment.

Upon receiving the clock enable signal, the emulator operation control unit 54 inputs an operation start interrupt signal to the cooperative operation control unit 61a in the software simulator 60. After that, the cooperative operation control unit 61a outputs synchronization/control information simultaneously to the emulator operation control unit 54 and the simulator operation control unit 61b to enable the clock. The emulator operation control unit 54 starts clock supply to the CPU core 52, and the simulator operation control unit 61b starts clock supply to the CPU core 63. That is, they start the operation simultaneously.

In the second embodiment as well, in debugging the CPU cores 52 and 63 in the hardware emulator 50 and the software simulator 60, when the value of the program counter has reached a breakpoint, it is possible to stop clock supply and stop the operations of the plurality of CPU cores 52 and 63 without any cycle error, as in the first embodiment. Hence, accurate debug is possible. Especially in developing a built-in device, cycle-dependent program design is done sometimes. This requires more accurate debug, and the first or second embodiment can be applied usefully.

According to the simulation apparatuses and simulation methods of the first and second embodiments, it is possible to increase the simulation accuracy by simultaneously stopping a CPU core that has reached a breakpoint and another CPU core.

The above-described embodiments are merely examples and do not limit the present invention. Various changes and modifications can be made within the technical scope of the present invention. For example, in the first embodiment, the debugger 30 includes only one breakpoint setting unit 32 so that only one breakpoint can be set, as shown in FIG. 3. However, a plurality of breakpoint setting units may be provided to set a plurality of breakpoints. In this case, clock supply stops at each breakpoint so that the operations of the CPU cores can be stopped simultaneously.

What is claimed is:

1. A simulation apparatus, comprising:
a hardware emulator which includes a first CPU core as a simulation target, and a debug control unit;
a software simulator which includes a second CPU core as a simulation target, and a clock generation unit which generates a clock and supplies the clock to the first CPU core and the second CPU core; and
a debugger which debugs the first CPU core and the second CPU core and in which a clock disable condition is set,
wherein upon determining that the clock disable condition set in said debugger is satisfied, said debug control unit outputs a clock disable signal, and
upon receiving the clock disable signal, said clock generation unit stops generating the clock.

2. An apparatus according to claim 1, wherein
said debugger includes a breakpoint setting unit in which a breakpoint is set, and
when an address of a program that is running in the first CPU core matches the breakpoint set in said breakpoint setting unit, said debug control unit determines that the clock disable condition set in said debugger is satisfied.

3. An apparatus according to claim 1, wherein
the first CPU core includes a program counter which stores an address of a program running in the first CPU core, and
said debugger includes a display unit which displays internal information of the first CPU core.

4. An apparatus according to claim 1, wherein
said debugger includes a breakpoint setting unit in which a breakpoint is set, and an operation start setting unit in which an operation start condition is set, and
when an address of a program that is running in the first CPU core matches the breakpoint set in said breakpoint setting unit, and a first value is set in said operation start setting unit, said debug control unit determines that the clock disable condition set in said debugger is satisfied, and outputs the clock disable signal.

5. An apparatus according to claim 4, wherein
said debugger includes a plurality of breakpoint setting units in which different breakpoints are set, and
when the address of the program that is running in the first CPU core matches one of the breakpoints set in said breakpoint setting units, and the first value is set in said operation start setting unit, said debug control unit determines that the clock disable condition set in said debugger is satisfied, and outputs the clock disable signal each time.

6. An apparatus according to claim 4, wherein
said debug control unit includes:
a breakpoint determination unit which receives the address of the program and the breakpoint, determines one of match and mismatch between the address and the breakpoint, and outputs one of a match signal and a mismatch signal; and
a logic circuit which outputs the clock disable signal upon receiving the match signal from said breakpoint determination unit and the first value from said operation start setting unit, and otherwise, outputs a clock enable signal, and
upon receiving the clock enable signal, said clock generation unit starts generating the clock and supplies the clock to the first CPU core and the second CPU core.

7. An apparatus according to claim 4, wherein
said debug control unit outputs a clock enable signal when a second value is set in said operation start setting unit in a state in which the clock disable signal is being output, and
upon receiving the clock enable signal, said clock generation unit starts generating the clock and supplies the clock to the first CPU core and the second CPU core.

8. A simulation apparatus, comprising:
a hardware emulator which includes a first CPU core as a simulation target, an emulator operation control unit which generates a clock and supplies the clock to the first CPU core, and a debug control unit;
a software simulator which includes a second CPU core as a simulation target, a simulator operation control unit which generates a clock and supplies the clock to the second CPU core, and a cooperative operation control unit which cooperates an operation of said emulator operation control unit and that of said simulator operation control unit; and
a debugger which debugs the first CPU core and the second CPU core and in which a clock disable condition is set,
wherein upon determining that the clock disable condition set in said debugger is satisfied, said debug control unit outputs a clock disable signal,
upon receiving the clock disable signal, said emulator operation control unit outputs an operation stop interrupt signal, and
upon receiving the operation stop interrupt signal, said cooperative operation control unit outputs synchronization/control information to said emulator operation control unit and said simulator operation control unit so that said emulator operation control unit and said simulator operation control unit stop generating the clock.

9. An apparatus according to claim 8, wherein
said debugger includes a breakpoint setting unit in which a breakpoint is set, and
when an address of a program that is running in the first CPU core matches the breakpoint set in said breakpoint setting unit, said debug control unit determines that the clock disable condition set in said debugger is satisfied.

10. An apparatus according to claim 8, wherein
the first CPU core includes a program counter which stores an address of a program running in the first CPU core, and
said debugger includes a display unit which displays internal information of the first CPU core.

11. An apparatus according to claim 8, wherein
said debugger includes a breakpoint setting unit in which a breakpoint is set, and an operation start setting unit in which an operation start condition is set, and
when an address of a program that is running in the first CPU core matches the breakpoint set in said breakpoint setting unit, and a first value is set in said operation start setting unit, said debug control unit determines that the clock disable condition set in said debugger is satisfied, and outputs the clock disable signal.

12. An apparatus according to claim 11, wherein
said debugger includes a plurality of breakpoint setting units in which different breakpoints are set, and
when the address of the program that is running in the first CPU core matches one of the breakpoints set in said breakpoint setting units, and the first value is set in said operation start setting unit, said debug control unit determines that the clock disable condition set in said debugger is satisfied, and outputs the clock disable signal each time.

13. An apparatus according to claim 11, wherein
said debug control unit includes:
a breakpoint determination unit which receives the address of the program and the breakpoint, determines one of match and mismatch between the address and the breakpoint, and outputs one of a match signal and a mismatch signal; and
a logic circuit which outputs the clock disable signal upon receiving the match signal from said breakpoint determination unit and the first value from said operation start setting unit, and otherwise, outputs a clock enable signal, and
upon receiving the clock enable signal, said emulator operation control unit outputs an operation start interrupt signal, and
upon receiving the operation start interrupt signal, said cooperative operation control unit outputs synchronization/control information to said emulator operation control unit and said simulator operation control unit so that said emulator operation control unit and said simulator operation control unit start generating the clock.

14. An apparatus according to claim 11, wherein
said debug control unit outputs a clock enable signal when a second value is set in said operation start setting unit in a state in which the clock disable signal is being output,
upon receiving the clock enable signal, said emulator operation control unit outputs an operation start interrupt signal, and
upon receiving the operation start interrupt signal, said cooperative operation control unit outputs synchronization/control information to said emulator operation control unit and said simulator operation control unit so that said emulator operation control unit and said simulator operation control unit start generating the clock.

15. A simulation method of executing simulation for debugging a first CPU core and a second CPU core by using a simulation apparatus including a hardware emulator which includes the first CPU core as a simulation target, and a debug control unit, a software simulator which includes the second CPU core as a simulation target, and a clock generation unit which generates a clock and supplies the clock to the first CPU core and the second CPU core, and a debugger which debugs the first CPU core and the second CPU core and in which a clock disable condition is set, comprising:
causing the debug control unit to determine whether the clock disable condition set in the debugger is satisfied; and
causing the clock generation unit to stop generating the clock when the debug control unit determines that the clock disable condition is satisfied.

16. A method according to claim 15, wherein
the debugger includes a breakpoint setting unit in which a breakpoint is set, and
in determining whether the clock disable condition is satisfied, the debug control unit determines whether an address of a program that is running in the first CPU core matches the breakpoint set in the breakpoint setting unit.

17. A method according to claim 15, wherein
the first CPU core includes a program counter which stores an address of a program running in the first CPU core, and
the method further comprises causing the debugger to display internal information of the first CPU core on a display unit.

18. A method according to claim 15, wherein
the debugger includes a breakpoint setting unit in which a breakpoint is set, and an operation start setting unit in which an operation start condition is set, and
in determining whether the clock disable condition is satisfied, when an address of a program that is running in the first CPU core matches the breakpoint set in the breakpoint setting unit, and a first value is set in the operation start setting unit, the debug control unit determines that the clock disable condition set in the debugger is satisfied.

19. A method according to claim 18, wherein
the debugger includes a plurality of breakpoint setting units in which different breakpoints are set, and
in determining whether the clock disable condition is satisfied, when the address of the program that is running in the first CPU core matches one of the breakpoints set in the breakpoint setting units, and the first value is set in the operation start setting unit, the debug control unit determines each time that the clock disable condition set in the debugger is satisfied.

20. A method according to claim 18, wherein
when a second value is set in the operation start setting unit in a state in which the clock disable signal is being output, the debug control unit determines that a condition for operating the clock is satisfied, and
when the debug control unit determines that the condition for operating the clock is satisfied, the clock generation unit starts generating the clock.
